(19) United States
(12) Patent Application Publication
(10) Pub. No.: US 2009/0208785 A1
(43) Pub. Date: Aug. 20, 2009

(54) SOFC electrochemical anode tail gas oxidizer

(75) Inventor: James F. McElroy, Suffield, CT (US)

Correspondence Address: FOLEY AND LARDNER LLP;SUITE 500, 3000 K STREET NW, WASHINGTON, DC, 20007, US

(73) Assignee: BLOOM ENERGY CORORATION

(21) Appl. No.: 12/071,396

(22) Filed: Feb. 20, 2008

(51) Int. Cl. H01M 8/06; H01M 8/10

(52) U.S. Cl. 429/17; 429/30

(57) ABSTRACT

A fuel cell system comprises a fuel cell stack comprising a plurality of fuel cells and at least one shorted solid oxide fuel cell in which the cell anode is electrically connected to the cell cathode. In another system, the at least one shorted solid oxide fuel cell is located downstream from a fuel cell stack. The at least one shorted fuel cell is positioned to receive the anode exhaust stream from at least some of the plurality of fuel cells of the fuel cell stack.

### BACKGROUND

The present invention relates generally to the field of fuel cell systems and more particularly to fuel exhaust separation and recycling schemes for fuel cells.

Fuel cells are electrochemical devices which can convert energy stored in fuels to electrical energy with high efficiencies. In certain fuel cell systems, such as a solid oxide fuel cell (SOFC) system, the anode exhaust stream contains a small amount of fuel. This fuel must be oxidized before discharge into the atmosphere or sequestration into CO₂. Typically, this fuel is oxidized with air in a combustion process in an oxidizer such as a burner or a catalyst reactor. However, the amount of fuel in the anode exhaust stream is often low and variable. As such, controlling a burner type oxidizer is difficult. Further, both the burner type and catalyst type oxidizers dilute the discharged stream with nitrogen from air, making sequestration of CO₂ also difficult.

### SUMMARY

One embodiment of the present invention describes a fuel cell system comprising a fuel cell stack comprising a plurality of fuel cells and at least one shorted fuel cell. In the shorted cell, the cell anode is electrically connected to the cell cathode. Further, the at least one shorted fuel cell is positioned within the stack to receive the anode exhaust stream from the plurality cells of the fuel cell stack.

Another embodiment describes a fuel cell system comprising a fuel cell stack and at least one shorted fuel cell or at least one shorted stack located downstream from the fuel cell stack. In the at least one shorted cell, the cell anode is electrically connected to the cell cathode. As in the previous embodiment, the at least one shorted fuel cell is positioned to receive the anode exhaust stream from the fuel cell stack.

Another embodiment describes a method of operating a fuel cell system comprising generating electricity using a fuel cell stack, providing an anode exhaust stream from fuel cells of the fuel cell stack to at least one shorted fuel cell and providing oxygen to the at least one shorted fuel cell. In at least one shorted fuel cell, at least one of H₂ and CO from the anode exhaust stream reacts with oxygen to form at least one of H₂O and CO₂, respectively.

### BRIEF DESCRIPTION OF THE DRAWINGS

FIG. 1A is a schematic view of a shorted SOFC in operation.

FIG. 1B is a schematic view of a shorted SOFC comprising a current shunt in operation.

FIG. 2A is a side cross-sectional view of a fuel cell stack comprising shorted cells.

FIG. 2B is a side cross sectional view of a shorted stack positioned down stream from a regular stack.

FIG. 2C is a schematic view of a fuel cell system in which a shorted stack is positioned downstream from a regular stack.

### DETAILED DESCRIPTION OF THE PREFERRED EMBODIMENTS

In an embodiment of the invention, fuel cell systems, such as SOFC systems, include additional shorted fuel cells, such as shorted SOFC cells or stacks for oxidizing residual fuel in system exhaust streams such as, but not limited to, fuel cell anode exhaust streams. As used herein. “shorted cell” denotes a fuel cell where the cell anode electrode is electrically connected to the cell cathode electrode. Also as used herein, “shorted stack” denotes a fuel cell stack where all the cells are shorted cells. For example, the shorted cell converts one or both of H₂ and CO in the exhaust stream into one or both of H₂O and CO₂, respectively. Additionally, the exhaust steam can be essentially free of N₂ and O₂ to facilitate CO₂ sequestration. Also, in order to optimize conditions for reacting the residual fuel in the exhaust streams, a shorted fuel cell can be fitted with a shunt (e.g., current sensor) to monitor the fuel cell reactions and determine if any flow rate adjustments are needed.

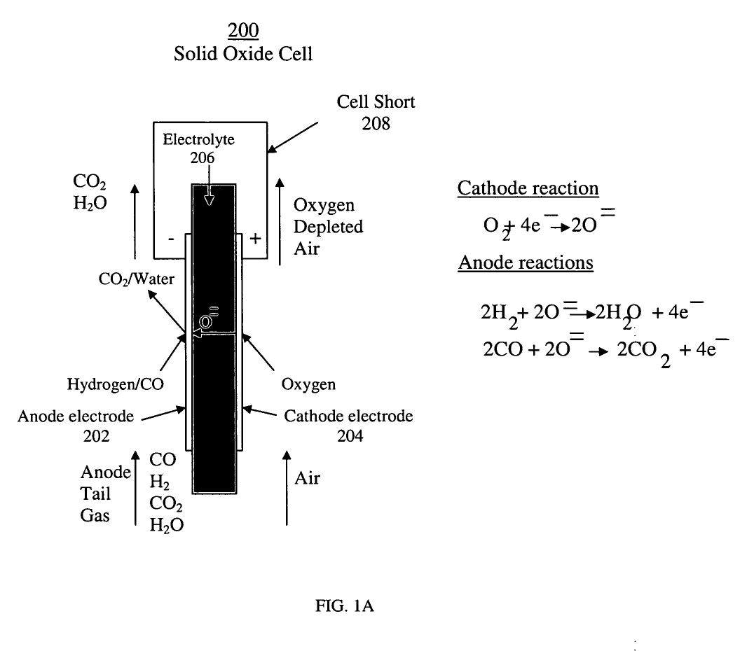

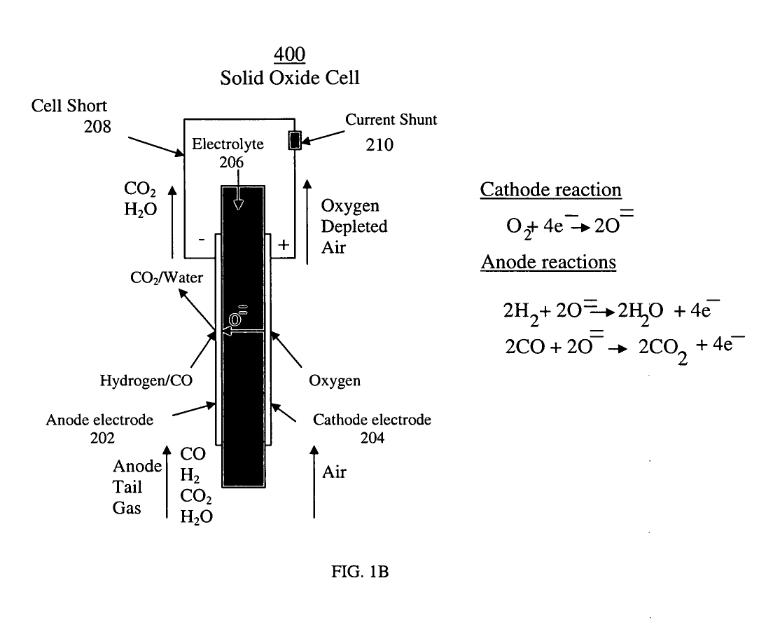

In FIG. 1A, a non-limiting example of a shorted solid oxide fuel cell 200 is shown in an operational context. One or more such shorted cells may be used. Accordingly, an anode exhaust stream (i.e. anode tail gas) comprising CO, H₂, CO₂ and H₂O from a non-shorted or regular fuel cell or stack flows into the anode chamber of the shorted cell 200. The cathode chamber receives a flow of air where oxygen gas is converted to O²⁻ ions, on the cathode electrode 204. The oxygen ions conduct though the electrolyte 206 of cell 200 to react with CO and H₂ on the anode electrode 202 to form CO₂ and H₂O respectively. Because the cell 200 is shorted with shorts 208 (which will be described below), all of the CO and H₂ are consumed, forming additional CO₂ and H₂O in the anode chamber. The amount of oxygen ions reacting on the anode will therefore match the amount of CO and H₂ and the flow of oxygen ions will stop when the reactants are all consumed. Thus, unreacted oxygen species will not dilute the anode exhaust of the shorted cell. Further, since the SOFC electrolyte is non-permeable to N₂, it prohibits any N₂ (from the air supplied to the cathode) from diluting the anode exhaust of the shorted cell.

In general, a fuel cell may be shorted in a variety of ways. One non-limiting example includes electrically connecting the anode and cathode electrodes with an external wire or other similar conductor. Another non-limiting example includes forming a channel through the electrolyte which is filled with an electrically conductive material, such as a metal. Another non-limiting example includes a mixed conductor electrolyte which is both ionically and electrically conductive. These are all examples of the shorts 208 shown in FIG. 1A. The electrically conductive material in the channel is in electrical contact with both the anode and the cathode to short the cell or conductive electrolyte as described below.

In one embodiment, the fuel cell system comprises a fuel cell stack comprising regular fuel cells (i.e., cells in which the anode is not shorted to the cathode) and at least one shorted fuel cell having the cell anode electrically connected to the cell cathode. The shorted fuel cells may be located at any part of the fuel cell stack. For instance, the shorted fuel cell may be located at the middle or end portions of a fuel cell stack between or after the regular cells. Preferably, the shorted fuel cell receives an exhaust stream, such as but not limited to an anode exhaust stream for the regular cells the stack. In some instances, a fuel cell stack can comprise more than one shorted fuel cell where each shorted fuel cell is located next to and/or distal from another shorted cell in the stack. As a non-limiting example, a SOFC stack may comprise eleven cells where the first ten cells are regular (non-shorted) cells and the last cell located down stream from the other ten cells is shorted.

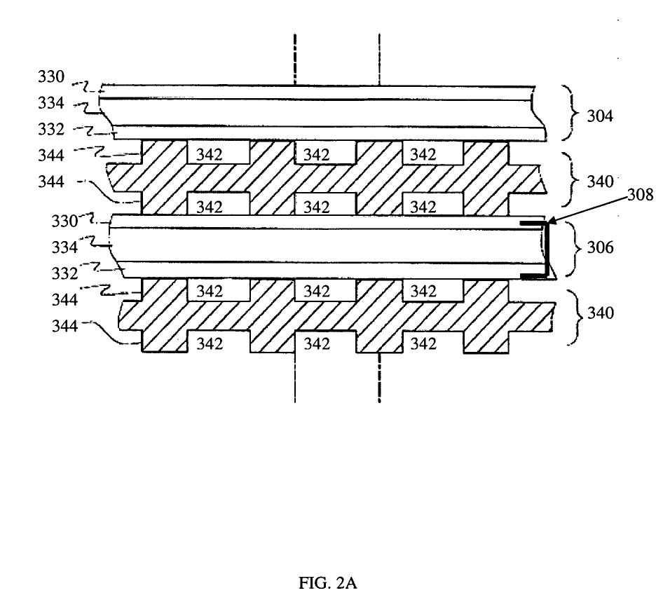

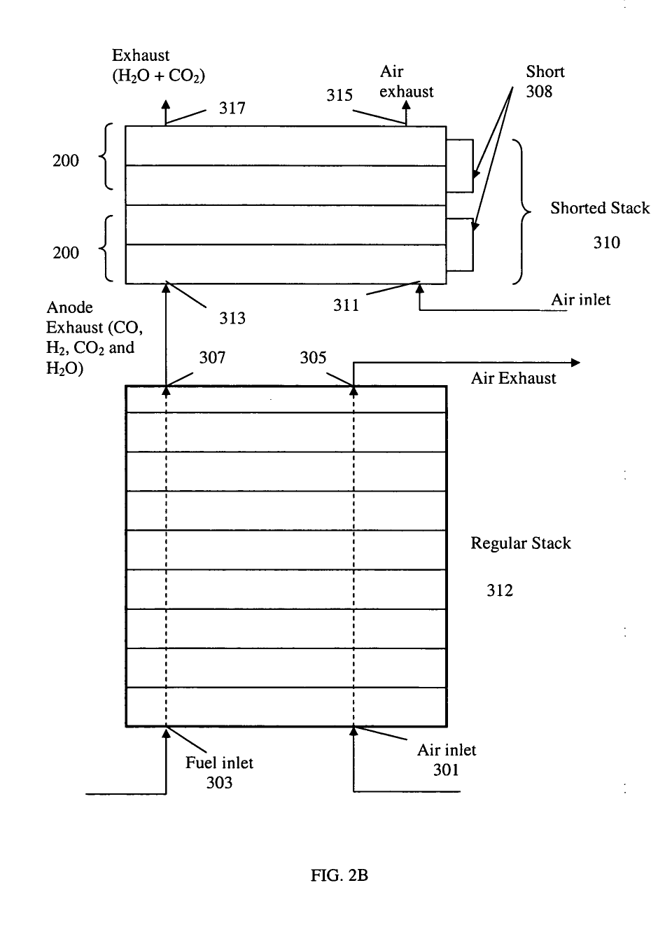

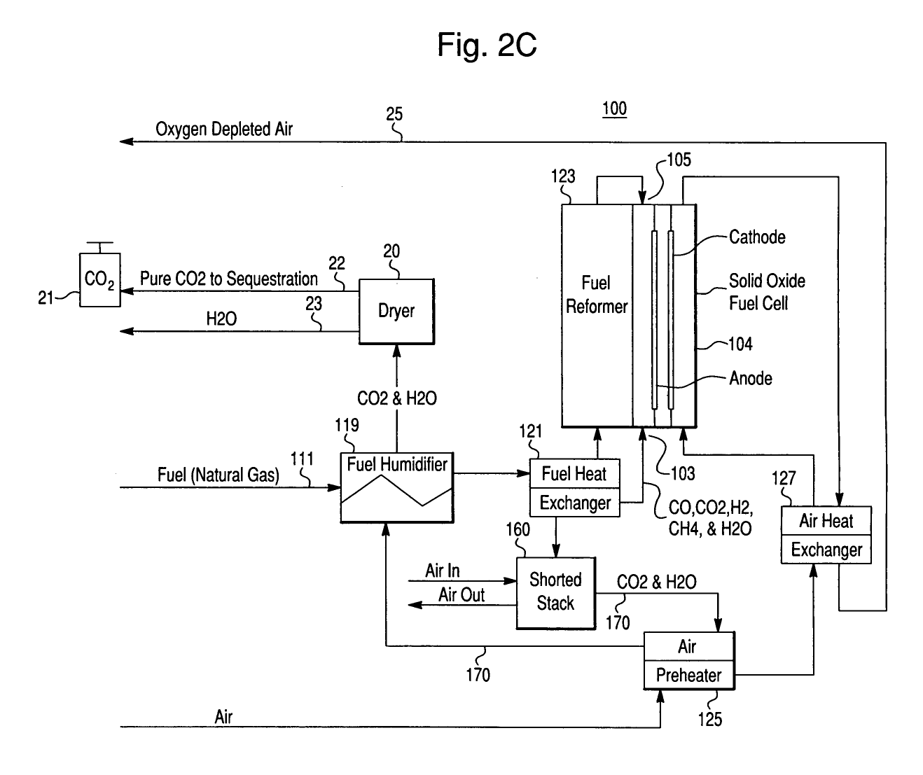

FIG. 2A is a non-limiting example of a fuel cell stack comprising both regular and shorted fuel cells located in the stack. As shown, the stack comprises both regular fuel cells 304 and shorted fuel cells 306. Each shorted cell may be electrically connected to another shorted cell if more than one shorted cell is used. In either case, each shorted cell 306 comprises a short 308. A shorted cell may also be electrically connected to a regular cell 304 via an interconnect 340 that also functions as a gas separator. The interconnect 340 separates the individual cells in the stack and also separates fuel, such as a hydrocarbon fuel, flowing to anode electrode 330 of one cell in the stack, from oxidant, such as air, flowing to the cathode electrode 332 of an adjacent cell in the stack. The interconnect 340 contains gas flow passages or channels 342 between the ribs 344. Further, the interconnect 340 electrically connects the anode electrode 330 of one cell to the cathode electrode 332 of the adjacent cell. The interconnect 340 comprises an electrically conductive material such as but not limited to, a metal alloy, such as a chromium-iron alloy, or an electrically conductive ceramic material. Preferably, but not necessarily, the interconnect material has a similar coefficient of thermal expansion to that of the fuel cell electrolyte 334. An electrically conductive contact layer, such as a nickel contact layer, may be provided between the anode electrode and the interconnect. Another optional electrically conductive contact layer may be provided between the cathode electrode and the interconnect. FIG. 2A shows that the lower SOFC 306 is located between two interconnects 340. While a vertically oriented stack is shown in FIG. 2A, the fuel cells may be stacked horizontally or in any other suitable direction between vertical and horizontal. Also, while not shown, the stack comprises more than one regular cell 304 and may comprise more than one shorted cell 306.

During operation of the stack in FIG. 2A, both air and fuel first enter the cathode and anode chambers of the regular fuel cells, respectively, through the respective air and fuel channels 342 of the interconnect 340. Air then continues to flow from the regular fuel cells 304 into the cathode chambers of the shorted fuel cells 306. The fuel exhaust stream from the anodes of the regular cells 304 flows into the anode chambers of the shorted fuel cells 306 where CO and H₂ are converted into CO₂ and H₂O respectively. Output of the stack comprises an air exhaust stream from the cathode side and CO₂ and H₂O from the anode side.

In another embodiment, a fuel cell system comprises a fuel cell stack (regular fuel cell stack) and at least one shorted fuel cell located downstream from the stack. The shorted fuel cell may be located in a shorted fuel cell stack or stacks, in which every cell's anode is shorted to the cathode. Such shorted stack(s) may be located at any part of the fuel cell system. Particularly, it may be located inside or outside the hot box area in which the regular stacks are located. Preferably, at least one shorted fuel cell stack receives an exhaust stream, such as but not limited to an anode exhaust stream, of a regular fuel cell stack.

FIG. 2B is a non-limiting example of a fuel cell system where a shorted solid oxide fuel cell stack 310 is located downstream from a regular solid oxide fuel cell stack 312. The shorted stack 310 comprises shorts 308 and is located to receive the anode exhaust stream from the regular stack 312. As shown, air and fuel enter the cathode and anode chambers, respectively of the regular stack 312 via respective inlets 301 and 303. Air is also supplied to the cathode chamber of the shorted cells. This air may comprise the cathode exhaust stream from stack 312 or fresh air stream. In both cases at least one of H₂ and CO flowing into the shorted cells are converted into at least one of H₂O and CO₂, respectively. With reference to FIG. 2B, cathode inlet 311 and anode inlet 313 of the shorted stack receive air and anode exhaust streams respectively, while air exhaust and fuel exhaust streams exit the shorted stack via cathode air outlet 315 and fuel outlet 317 respectively.

Preferably, in a shorted stack, the fuel content is uniformly distributed throughout the cells. This can ensure that the current passes through each cell and the cell does not pump oxygen into the exhaust stream. For example, when a cell in a shorted stack contains an undesirable concentration of fuel, the cell can be driven by other cells into oxygen pumping mode which contaminates the anode exhaust stream with oxygen gas. An effective solution is to employ a mixed conductor electrolyte in the shorted cells. A mixed conductor electrolyte conducts both oxygen ions and electrons (i.e., it is both ionically and electrically conductive).

A non-limiting example of such electrolytes is a mixture of doped ceria and stabilized zirconia where there is limited reaction between the ceria and zirconia phases. Examples of stabilized zirconias include scandia stabilized zirconia (SSZ) (scandia ceria stabilized zirconia (“SCSZ”)), and/or yttria stabilized zirconia (YSZ). Non-limiting examples of doped ceria includes 10 to 40 molar percent trivalent oxides of ceria. The doped ceria is preferably slightly non-stoichiometric with less than two oxygen atoms for each metal atom: Ce₁₋ₘDₘO_{2-δ} where 0.1≦m≦0.4 and D is selected from one or more of La, Sm, Gd, Pr or Y. However, a doped ceria containing two or more oxygen atoms for each metal atom may also be used. For example, the doped ceria may comprise gadolinia doped ceria (“GDC”). In another non-limiting example, a single phase doped ceria material, such as GDC, is used as a mixed conductor electrolyte which conducts both oxygen ions and electrons.

Preferably, when using shorted stacks, the reaction rates in the anode chamber of the shorted stack is known. The reaction rates can be generally assessed by knowing the air flow rate and measuring the effluent diluted air content. Therefore, one method comprises measuring flow rate of oxygen into the stack of shorted fuel cells, measuring effluent oxygen in said stack of shorted fuel cells and adjusting a flow of oxygen to optimize flow of oxygen. Another method comprises measuring current from a sensor fuel cell in the stack adjusting the air flow to optimize flow of oxygen. FIG. 1B is a non-limiting example of a shorted fuel cell also comprising a current shunt (e.g. current sensor). As described in further detail below, the current sensor may be used to monitor the reactions in the anode chamber to make necessary system adjustments. As shown in FIG. 1B, a SOFC sensor cell 400 (without the mixed conductor electrolyte) can be placed within a stack of mixed conductor electrolyte cells to measure the current from this cell. Current in the sensor cell can be measured via a current shunt 210. The SOFC sensor cell 400 both oxidizes fuel and provides an instant accurate reaction rate. In this example, the cell 400 is externally shorted and the current is instantly measured via shunt 210. Since in general, the flow of fluids through each anode chamber (including that of sensor cell 400) is within about 5% of the other cells, an accurate assessment of the input fuel content is instantly available based on current measurements from sensor cell 400. This in turn allows system monitoring to make adjustments for ensuring adequate air provided to the cells and that the system is run efficiently.

FIG. 2C is non-limiting example of a fuel cell system 100 comprising a shorted fuel cell stack 160 located down stream from a fuel cell stack 101 (regular stack) in addition to other components of a fuel cell system.

The system 100 contains an exhaust conduit 170 which operatively connects the anode exhaust outlet from the shorted stack 160 to a carbon dioxide storage tank or other vessel 21 for sequestering carbon dioxide and/or water. Preferably, the exhaust conduit 170 is connected to a dryer 20 that separates the carbon dioxide from the water contained in the exhaust stream. The dryer 20 can use any suitable means for separating carbon dioxide from water, such as separation based on differences in melting point, boiling point, vapor pressure, density, polarity, or chemical reactivity. Preferably, the separated carbon dioxide is substantially free of water and has a relatively low dew point. Preferably, the separated carbon dioxide is sequestered in the vessel 21 in order to minimize greenhouse gas pollution by the system 100.

The system 100 further contains a fuel humidifier 119 having a first inlet operatively connected to a hydrocarbon fuel source, such as the hydrocarbon fuel inlet conduit 111, a second inlet operatively connected to the fuel exhaust outlet 103, a first outlet operatively connected to the fuel cell stack fuel inlet 105, and a second outlet operatively connected to the dryer 20. In operation, the fuel humidifier 119 humidifies a hydrocarbon fuel inlet stream from conduit 111 using water vapor contained in a fuel cell stack fuel exhaust stream. The fuel humidifier may comprise a polymeric membrane humidifier, such as a Nafion® membrane humidifier, an enthalpy wheel or a plurality of water adsorbent beds, as described for example in U.S. Pat. No. 6,106,964 and in U.S. application Ser. No. 10/368,425, which published as U.S. Published Application Number 2003/0162067, all of which are incorporated herein by reference in their entirety. For example, one suitable type of humidifier comprises a water vapor and enthalpy transfer Nafion® based, water permeable membrane available from Perma Pure LLC. The humidifier passively transfers water vapor and enthalpy from the fuel exhaust stream into the fuel inlet stream to provide a 2 to 2.5 steam to carbon ratio in the fuel inlet stream. The fuel inlet stream temperature may be raised to about 80 to about 90 degrees Celsius in the humidifier.

The system 100 also contains a recuperative heat exchanger 121 which exchanges heat between the stack 101 fuel exhaust stream and the hydrocarbon fuel inlet stream being provided from the humidifier 119. The heat exchanger helps to raise the temperature of the fuel inlet stream and reduces the temperature of the fuel exhaust stream so that it may be further cooled downstream and such that it does not damage the humidifier.

If the fuel cells are external fuel reformation type cells, then the system 100 contains a fuel reformer 123. The reformer 123 reforms a hydrocarbon fuel containing inlet stream into hydrogen and carbon monoxide containing fuel stream which is then provided into the stack 101. The reformer 123 may be heated radiatively, convectively and/or conductively by the heat generated in the fuel cell stack 101, as described in U.S. patent application Ser. No. 11/002,681, filed Dec. 2, 2004, which published as U.S. Published Application Number 2005/0164051, incorporated herein by reference in its entirety. Alternatively, the external reformer 123 may be omitted if the stack 101 contains cells of the internal reforming type where reformation occurs primarily within the fuel cells of the stack.

Optionally, the system 100 also contains an air preheater heat exchanger 125. This heat exchanger 125 heats the air inlet stream being provided to the fuel cell stack 101 using the heat of the fuel cell stack fuel exhaust. If desired, this heat exchanger 125 may be omitted.

The system 100 also preferably contains an air heat exchanger 127. This heat exchanger 127 further heats the air inlet stream being provided to the fuel cell stack 101 using the heat of the fuel cell stack air (i.e., oxidizer or cathode) exhaust. If the preheater heat exchanger 125 is omitted, then the air inlet stream is provided directly into the heat exchanger 127 by a blower or other air intake device.

The system may optionally comprise a hydrogen separation unit (not shown) such as a Proton Exchange Membrane (PEM) fuel cell stack, to separate any remaining hydrogen in the fuel exhaust stream, as described in U.S. patent application Ser. No. 11/730,255, filed on Mar. 30, 2007 and incorporated herein by reference in its entirety.

The system may also optionally contain a hydrogen cooler heat exchanger (not shown) which cools the separated hydrogen stream, for example provided from a PEM stack, using an air stream, such as an air inlet stream.

The system 100 operates as follows. A fuel inlet stream is provided into the fuel cell stack 101 through fuel inlet conduit 111. The fuel may comprise any suitable fuel, such as a hydrocarbon fuel, including but not limited to methane, natural gas which contains methane with hydrogen and other gases, propane, methanol, ethanol or other biogas, or a mixture of a carbon fuel, such as carbon monoxide, oxygenated carbon containing gas, such as ethanol, methanol, or other carbon containing gas with a hydrogen containing gas, such as water vapor, H₂ gas or their mixtures. For example, the mixture may comprise syngas derived from coal or natural gas reformation.

The fuel inlet stream passes through the humidifier 119 where humidity is added to the fuel inlet stream. The humidified fuel inlet stream then passes through the fuel heat exchanger 121 where the humidified fuel inlet stream is heated by the fuel cell stack fuel exhaust stream. The heated and humidified fuel inlet stream is then provided into a reformer 123, which is preferably an external reformer. For example, reformer 123 may comprise a reformer described in U.S. patent application Ser. No. 11/002,681, filed on Dec. 2, 2004, which published as U.S. Published Application Number 2005/0164051, incorporated herein by reference in its entirety. The fuel reformer 123 may be any suitable device which is capable of partially or wholly reforming a hydrocarbon fuel to form a carbon containing and free hydrogen containing fuel. For example, the fuel reformer 123 may be any suitable device which can reform a hydrocarbon gas into a gas mixture of free hydrogen and a carbon containing gas. For example, the fuel reformer 123 may comprise a nickel and rhodium catalyst coated passage where a humidified biogas, such as natural gas, is reformed via a steam-methane reformation reaction to form free hydrogen, carbon monoxide, carbon dioxide, water vapor and optionally a residual amount of unreformed biogas. The free hydrogen and carbon monoxide are then provided into the fuel (i.e., anode) inlet 105 of the fuel cell stack 101. Thus, with respect to the fuel inlet stream, the humidifier 119 is located upstream of the heat exchanger 121 which is located upstream of the reformer 123 which is located upstream of the stack 101.

The air or other oxygen containing gas (i.e., oxidizer) inlet stream is preferably provided into the stack 101 through a heat exchanger 127, where it is heated by the air (i.e., cathode) exhaust stream from the fuel cell stack. If desired, the air inlet stream may also pass through the air preheat heat exchanger 125 to further increase the temperature of the air before providing the air into the stack 101. Preferably, no fuel is combusted with air, and if heat is required during startup, then the requisite heat is provided by the electric heaters which are located adjacent to the stack 101 and/or the reformer 123.

Once the fuel and air are provided into the fuel cell stack 101, the stack 101 operates to generate electricity. The anode exhaust stream of the stack 101 comprises CO, and H₂ and optionally CH₄, CO₂ and H₂O. This stream is directed through the fuel heat exchanger 121 into the anode inlet of the shorted stack 160. Air is directed into the cathode inlet of the shorted stack 160 via an air inlet conduit 180 to supply oxygen. Air supply to the shorted stack 160 may be from split from the line providing air to the regular stack 101 or a separate source or it may comprise the stack 101 air exhaust in conduit 25. Furthermore, air exhaust from the shorted stack, may be routed back into the system or directed out of the system via air exhaust conduit 190. The shorted stack 160 converts CO and H₂ into CO₂ and H₂O respectively. The anode exhaust stream from the shorted stack, is essentially free of H₂ and CO, and is directed into the air preheater 125 and eventually to the vessel 21 via exhaust conduit 170. Optionally, a water-gas shift reactor can be used, either before of after a shorted stack, to react other possible stream components such as CH₄.

The anode exhaust stream from the shorted stack comprising CO₂, and H₂O is provided to the dryer 20 which separates carbon dioxide from water. Although not shown, the anode exhaust stream from the shorted stack 160 can bypass the air preheater 125 and go directly into fuel humidifier 119, or the dryer 20. The separated carbon dioxide then flows from the dryer 20 through conduit 22 into the vessel 21. In one example, if the fuel cell stack 101 comprises a solid oxide regenerative fuel cell stack, then with the aid of a Sabatier reactor, the sequestered carbon dioxide can be used to generate a hydrocarbon fuel, such as methane, when the stack 101 operates in the electrolysis mode, as described in U.S. Pat. No. 7,045,238, incorporated herein by reference in its entirety. The separated water from dryer 20 is available for humidification of the fuel inlet stream or other industrial uses. For example, conduit 23 may provide the water from the dryer 20 back into the humidifier 119, into a steam generator (not shown) and/or directly into the fuel inlet conduit 111.

In the fuel humidifier 119, a portion of the water vapor in the fuel exhaust stream is transferred to the fuel inlet stream to humidify the fuel inlet stream. The hydrocarbon and hydrogen fuel inlet stream mixture is humidified to 80C to 90C dew point. The remainder of the fuel exhaust stream is then provided into the dryer 20. The dryer 20 then separates the carbon dioxide from the water contained in the exhaust stream. The dry, substantially hydrogen free separated carbon dioxide is then provided to the containment unit 21 for sequestration, and the separated water is available for humidification of the fuel inlet stream or other industrial uses. Thus, the environmentally friendly system preferably contains no burner and the fuel exhaust is not combusted with air. The only exhaust from the system consists of three streams—water, sequestered carbon dioxide and oxygen depleted air cathode exhaust stream through conduit 25.

The fuel cell system described herein may have other embodiments and configurations, as desired. Other components may be added if desired, as described, for example, in U.S. application Ser. No. 10/300,021, filed on Nov. 20, 2002 and published as U.S. Published Application Number 2003/0157386, in U.S. Provisional Application Ser. No. 60/461,190, filed on Apr. 9, 2003, and in U.S. application Ser. No. 10/446,704, filed on May 29, 2003 and published as U.S. Published Application Number 2004/0202914, all of which are incorporated herein by reference in their entirety. Furthermore, it should be understood that any system element or method step described in any embodiment and/or illustrated in any figure herein may also be used in systems and/or methods of other suitable embodiments described above, even if such use is not expressly described.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A fuel cell system comprising:
a fuel cell stack comprising:
a plurality of fuel cells; and
at least one shorted solid oxide fuel cell in which the cell anode is electrically connected to the cell cathode,
wherein the at least one shorted fuel cell is positioned to receive an anode exhaust stream from at least some of the plurality of fuel cells of the fuel cell stack.

2. The fuel cell system of claim 1, wherein the at least one shorted fuel cell comprises a mixed electrolyte that is both ionically and electrically conductive.

3. The fuel cell system of claim 2, wherein the mixed electrolyte comprises a mixture of doped ceria and stabilized zirconia.

4. The fuel cell system of claim 1, wherein the at least one shorted fuel cell comprises a conductor-filled channel extending through the electrolyte electrically connecting the cell anode to the cell cathode.

5. The fuel cell system of claim 1, wherein the at least one shorted fuel cell comprises an external wire electrically connecting the cell anode to the cell cathode.

6. The fuel cell system of claim 1, further comprising a device which is adapted to separate H₂O from CO₂ and a device which is adapted store the separated CO₂.

7. A fuel cell system comprising:
a fuel cell stack; and
at least one shorted solid oxide fuel cell located downstream from the fuel cell stack, said at least one shorted fuel cell having the cell anode electrically connected to the cell cathode,
wherein the at least one shorted fuel cell is positioned to receive an anode exhaust stream from the fuel cell stack.

8. The fuel cell system of claim 7, wherein the at least one shorted fuel cell is located in a shorted fuel cell stack.

9. The fuel cell system of claim 7, wherein the at least one shorted fuel cell comprises a mixed electrolyte that is both ionically and electrically conductive.

10. The fuel cell system of claim 9, wherein the mixed electrolyte comprises a mixture of doped ceria and stabilized zirconia.

11. The fuel cell system of claim 7, wherein the at least one shorted fuel cell comprises a conductor-filled channel extending through the electrolyte electrically connecting the cell anode to the cell cathode.

12. The fuel cell system of claim 7, wherein the at least one shorted fuel cell comprises an external wire electrically connecting the cell anode to the cell cathode.

13. The fuel cell system of claim 7, further comprising a device which is adapted to separate H₂O from CO₂ and a device which is adapted store the separated CO₂.

14. A method of operating a fuel cell system comprising:
generating electricity using a fuel cell stack;
providing an anode exhaust stream from fuel cells of the fuel cell stack to at least one shorted solid oxide fuel cell; and
providing oxygen to the at least one shorted fuel cell, and reacting at least one of H₂ or CO in the anode exhaust stream with the oxygen to generate at least one of H₂O or CO₂.

15. The method of claim 14, wherein the at least one shorted fuel cell is located in a stack of shorted fuel cells located downstream from the electricity generating fuel cell stack.

16. The method of claim 15, further comprising measuring flow rate of oxygen into the stack of shorted fuel cells, measuring effluent oxygen in said stack of shorted fuel cells and adjusting a flow of oxygen to optimize flow of oxygen.

17. The method of claim 15, further comprising providing at least one sensor fuel cell located in the stack of shorted cells, wherein the at least one sensor cell comprises a current shunt electrically connected between the cell anode and cell cathode.

18. The method of claim 17, further comprising measuring current from the sensor fuel cell and adjusting the air flow to optimize flow of oxygen.

19. The method of claim 14, wherein the at least one shorted fuel cell is located in the electricity generating fuel cell stack.

20. The method of claim 14, further comprising separating CO₂ from H₂O generated by the at least one shorted solid oxide fuel cell and storing the separated CO₂.

21. The method of claim 14, further comprising providing the separated H₂O into a fuel inlet stream and providing the fuel inlet stream into the electricity generating fuel cell stack.
